(19) United States
(12) Patent Application Publication
(10) Pub. No.: US 2009/0244449 A1
(43) Pub. Date: Oct. 1, 2009

(54) LIQUID CRYSTAL DISPLAY DEVICE

(75) Inventors: Kenji Yoshioka, Kanagawa (JP); Hiroyuki Sekine, Kanagawa (JP)

Correspondence Address: YOUNG & THOMPSON, 209 Madison Street, Suite 500, ALEXANDRIA, VA, 22314, US

(73) Assignee: NEC LCD TECHNOLOGIES, LTD., Kanagawa (JP)

(21) Appl. No.: 12/394,432

(22) Filed: Feb. 27, 2009

(30) Foreign Application Priority Data
Mar. 28, 2008 (JP) 86524/2008

(51) Int. Cl. G02F 1/1335

(52) U.S. Cl. 349/106

(57) ABSTRACT

In a liquid crystal display device, a first substrate is provided with sub-pixels arranged in an array such that each sub-pixel is arranged in each partitioned area surrounded with wiring lines respectively extending in a direction so as to be crossed each other. A second substrate is provided with color layers such that three consecutive sub-pixels with three color layers as one unit are repeatedly arranged in a predetermined pattern, and a primary color layer for a first sub-pixel of said three sub-pixels and other color layer extended from an adjacent sub-pixel next to the first sub-pixel are arranged on an area opposing to an aperture of at least one sub-pixel among the three sub-pixels. And a liquid crystal layer sandwiched between the first substrate and the second substrate.

### This application is based upon and claims the benefit of priority from Japanese patent application No. 2008-086524, filed on Mar. 28, 2008 and the disclosure of which is incorporated herein in its entirety by reference.

### TECHNICAL FIELD

The present invention relates to a liquid crystal display device and in particular, relates to an arrangement of color layers on a color filter substrate.

### BACKGROUND ART

Liquid crystal display (LCD) devices are widely used for LCD televisions and mobile terminals due to its high-quality image display ability together with thin and light-weight characteristics. The LCD devices can be classified into three types, one is a transparent type accompanied with a backlight module including a light source, a reflective type utilizing ambient light, and a transflective type having both of above-stated two types. Among these types, the transparent type is often used for the one which displays video signals as represented by LCD televisions. This is because the chromaticity area which is a color range of the LCD device can be changed to a desired range by designing for it.

FIG. 11 is a cross sectional view of the transparent type LCD device 1 which includes a liquid crystal display (LCD) panel 2 and a backlight module 3 as a light source. The LCD panel 2 includes a liquid crystal layer 30 sandwiched between a pair of substrates provided with optical films such as polarizers 4a and 4b. Switching elements such as TFTs (Thin Film Transistors) for driving pixel electrodes are usually arranged on one of the substrates. Hereinafter, this substrate is called a TFT substrate 10. Color layers 22 used for color filters such as a red (R), a green (G) and a blue (B) are arranged on the other substrate, and hereinafter, this substrate is called as a CF (Color Filter) substrate 20. Theoretically, a chromaticity area of the LCD device 1 can be arbitrarily changed by changing an emission spectrum from the backlight module 3 and spectral transmittance characteristic of the color layers 22.

However, the chromaticity area cannot be varied perfectly due to the fact that actual available light sources and material of color resist used for the color layer 22 are limited. For example, when a chromaticity area 301 in FIG. 12 is requested, while the spectrum of the light source is BL2 in FIG. 13, and the spectra of the color resists are CF_R, CF_G and CF_B as shown in FIG. 13, a resulted chromaticity area 302 is not identical to the requested chromaticity as shown in FIG. 12. Accordingly, in order to adjust the spectrum of the light source to the chromaticity area 301 in FIG. 12, a new light source spectrum BL1 is needed as shown in FIG. 13. Therefore, it is extremely difficult to change the spectrum of the light source and the characteristic of the color resists in accordance with the purpose in each case.

In particular, in the case of the LCD television which requires a wide chromaticity area, the chromaticity area attained by the LCD device is generally set more widely than the requested chromaticity area. Moreover, it is general to operate the LCD device such that video signals supplied thereto are treated with data processing so that a displayed image is to be identical to the requested chromaticity area. For example, the technology which corrects the chromaticity by a correction circuit is disclosed In Japanese Patent Application Laid-Open No. 2002-44677 (patent document 1), and the chromaticity is being corrected in the linear summation of three colors of the input signal SG, SB and SR as shown in FIG. 14.

In FIG. 14, reference numerals 423 and 424 refer to multipliers that multiply a signal SG for a green by the mixture coefficients KGB and KGR, respectively, reference numerals 425 and 426, multipliers that multiply a signal SB for a blue by the mixture coefficients KBG and KBR, respectively, reference numerals 427 and 428, multipliers that multiply a signal SR for a red by the mixture coefficients KRG and KRB, respectively, and reference numeral 429 refers to an adder. This circuit realizes the above-mentioned operations.

This circuit carries out the following correction procedure.

SG′=SG+KBG·SB+KRG·SR

SB′=SB+KGB·SG+KRB·SR

SR′=SR+KGR·SG+KBR·SB

where,

KBG: Mixture coefficient of the B signal for the G signal

KRG: Mixture coefficient of the R signal for the G signal

KGB: Mixture coefficient of the G signal for the B signal

KRB: Mixture coefficient of the R signal for the B signal

KGR: Mixture coefficient of the G signal for the R signal

KBR: Mixture coefficient of the B signal for the R signal

When the above-mentioned processing is not performed, the color tone of the displayed image actually shifts and gives uneasiness. Therefore, the correction is needed by performing the above-mentioned signal processing. However, in order to add the data processing to the above-mentioned video signal, the arithmetic circuit which deals with the video signal at high speed is needed, and there is a problem which increases the cost of the LCD device.

On the other hand, Japanese Patent Application Laid-Open No. 2005-141180 (patent document 2) discloses a technology which adjusts the chromaticity of the transmissive region by changing the size of the chromaticity-adjusting region arranged in each sub-pixel and the film thickness of the color layer as shown in FIG. 15. In this example, a red layer 502a, a green layer 502b and a blue layer 502c have chromaticity-adjusting regions 503a, 503b and 503c, respectively, and each chromaticity area is being adjusted by adding color layer having different transmittance characteristics.

In that technique, however, when the pixel size becomes small, its fabrication becomes difficult. As shown in FIG. 2A, the pattern of a color layer 502 is generally formed by using a photolithographic technique as shown in FIG. 2B. By applying exposure light 500 on the color photo resist layer 512 through a photo mask 530, and developing it, when an opening of chromaticity-adjusting region 503 is provided, it undergoes the influence of the diffraction and the etching characteristic of the exposure light peculiar to photolithographic technique, and as shown in FIG. 2C, the end face of the color layer 502 and the chromaticity-adjusting region 503 tends to have a shape with inclination. When an isolated opening as shown in FIG. 2 is provided, this phenomenon is remarkable. When the size of the opening is small, that is caused by the etchant not flowing sufficiently. Therefore, it is difficult to form the minute opening pattern.

When the pixel size becomes smaller, the distance from the end of the chromaticity-adjusting region to the shielding region becomes relatively short. When a mating or a fitting deviates from a correct position that is, an overlapping error for a pair of substrates occurs, the shielding region on the TFT side is overlapped on the end of the chromaticity-adjusting region, and the proportion of the chromaticity-adjusting region in the sub-pixel may change. Therefore, a ratio of an area of the chromaticity-adjusting region and an area of the transmissive region is changed, and thus the chromaticity area changes.

Thus, changing the chromaticity area by adjusting the emission spectrum and the spectral transmission characteristic has enormous obstacle in view of the reality of the restriction of the kind of light sources and the material of the color resist.

In the method of applying a calculation to the video signal, the arithmetic circuit which deals with the video signal at high speed is needed, and there is a problem that it increases the cost of the LCD device.

In the method of providing the chromaticity-adjusting region in each sub-pixel, because the chromaticity-adjusting region is arranged alone, when the minute pattern formation with high definition is difficult, and when the fitting of a pair of substrates is deviated from the correction position, there is a problem that the proportion of the chromaticity-adjusting region to the transmissive region shifts and thus being deviated from an aimed chromaticity.

### SUMMARY

An exemplary object of the present invention is to provide an LCD device which can easily change the chromaticity area.

A liquid crystal display device according to an exemplary aspect of the present invention includes a liquid crystal layer sandwiched between a first substrate and a second substrate. The first substrate is provided with sub-pixels arranged in an array such that each sub-pixel is arranged in each partitioned area surrounded with wiring lines respectively extending in a direction so as to be crossed each other. The second substrate is provided with color layers such that three consecutive sub-pixels with three color layers as one unit are repeatedly arranged in a predetermined pattern, and a primary color layer for a first sub-pixel of the three sub-pixels and other color layer extended from an adjacent sub-pixel next to the first sub-pixel are arranged on an area opposing to an aperture of at least one sub-pixel among the three sub-pixels.

### BRIEF DESCRIPTION OF THE DRAWINGS

Exemplary features and advantages of the present invention will become apparent from the following detailed description when taken with the accompanying drawings in which:

FIG. 1A is a plan view showing a structure of a CF substrate of the LCD device according to a first exemplary embodiment of the present invention.

FIG. 1B is a plan view showing a structure of a TFT substrate of the LCD device according to the first exemplary embodiment of the present invention.

FIG. 1C is a cross sectional view of the LCD device according to the first exemplary embodiment of the present invention taken along the I-I line of FIG. 1A.

FIG. 1D is a plan view showing a structure of a pattern of a pixel of each color layer in the CF substrate of the LCD device according to the first exemplary embodiment of the present invention.

FIG. 2A is a plan view showing a color layer having a conventional chromaticity-adjusting region.

FIG. 2B is a cross sectional view for explaining a photolithographic technique used for forming the conventional chromaticity-adjusting region into the conventional color layer.

FIG. 2C is a cross sectional view showing a state of the chromaticity-adjusting region after a development process succeeding the step shown in FIG. 2B.

FIG. 3 is a schematic plan view illustrating a case wherein the CF substrate and the TFT substrate are deviated from a correct position in a horizontal direction, i.e. an extending direction of a gate line.

FIG. 4 is a schematic plan view illustrating a case wherein the CF substrate and the TFT substrate are deviated from the correct position in a longitudinal direction, i.e., an extending direction of a data line.

FIG. 5 is a chromaticity diagram showing a case wherein a color of green is added into the colors of blue and red.

FIG. 6 is a plan view showing a structure of the CF substrate according to a second exemplary embodiment of the present invention.

FIG. 7 is a plan view showing a structure of the CF substrate according to a third exemplary embodiment of the present invention.

FIG. 8A is a plan view showing a structure of the CF substrate according to a fourth exemplary embodiment of the present invention.

FIG. 8B shows an example of the chromaticity diagram.

FIG. 9 is a plan view showing a structure of the CF substrate according to a fifth exemplary embodiment of the present invention.

FIG. 10 is a cross sectional view showing a structure of a columnar spacer.

FIG. 11 is a cross sectional view showing a structure of a conventional LCD device.

FIG. 12 is a chromaticity area of the LCD device in a related art.

FIG. 13 is a diagram showing spectrum of the color layer of the LCD device and the light source.

FIG. 14 shows a chromaticity correction circuit disclosed in the patent document 1.

FIG. 15 is a plan view showing a color filter structure shown in the patent document 2.

### EXEMPLARY EMBODIMENT

In a preferred exemplary embodiment of the LCD device according to the present invention, a TFT substrate is provided with sub-pixels arranged in each partitioned area surrounded with wiring lines such as gate lines (scanning lines) and data lines (signal lines) each extending in a direction approximately crossing at right angles each other, while a CF substrate is provided with a consecutively arranged three sub-pixels as one pixel such that three color layers of red, green and blue are repeatedly arranged in a predetermined pattern. An LC layer is sandwiched between the TFT substrate and the CF substrate. On the CF substrate, a primary color layer for a first sub-pixel of sa id three sub-pixels and other color layer extended from an adjacent sub-pixel next to said first sub-pixel are arranged on an area opposing to an aperture portion of at least one sub-pixel among said three sub-pixels.

### Exemplary Embodiment 1

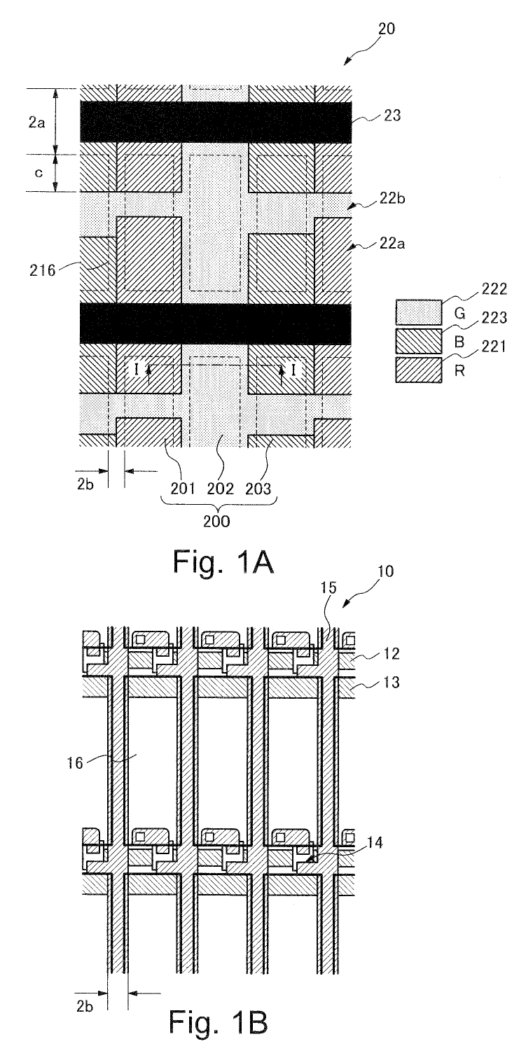

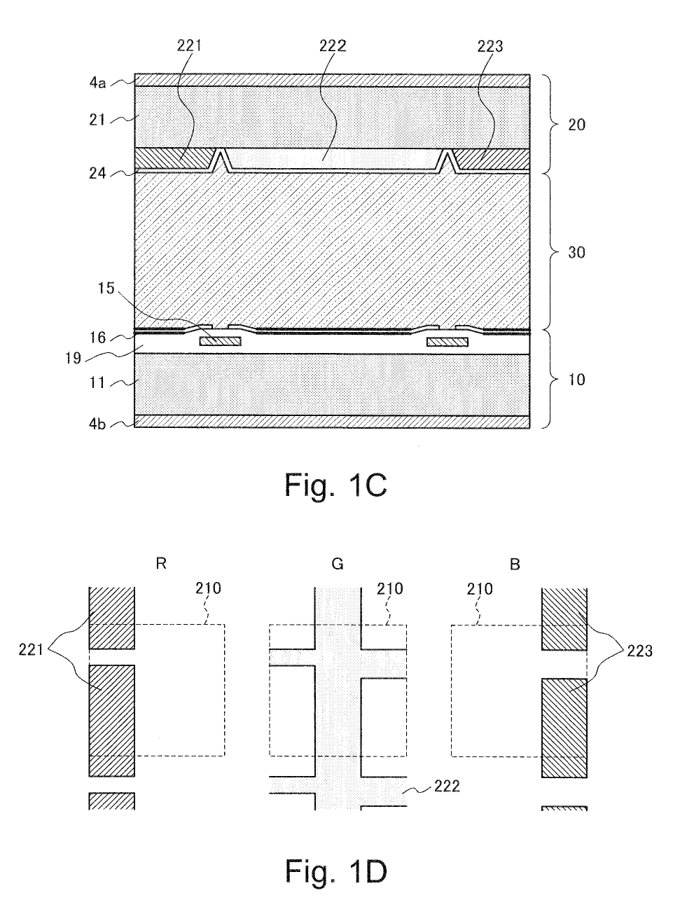

In order to describe the exemplary embodiment of the above-mentioned present invention more in detail, the LCD device according to the first exemplary embodiment of the present invention will be described with reference to FIG. 1 to FIG. 5.

FIG. 1A indicates a pixel area layout of the CF substrate of the LCD device according to the first exemplary embodiment of the present invention, and FIG. 1B indicates a layout of the TFT substrate corresponding to FIG. 1A. FIG. 1C is a cross sectional view taken along the I-I line shown in FIG. 1A, and FIG. 1D is a plan view showing a pattern structure of each color layer in one pixel.

As shown in FIG. 1C, the LCD device of this exemplary embodiment has the structure that the CF substrate 20 and the TFT substrate 10 are bonded together to form a gap and an LC layer 30 is disposed in the gap so as to be sandwiched between them. In the LCD device of this exemplary embodiment, one pixel is composed by a sub-pixel 201 (hereinafter referred to as an R-cell 201) which displays a red color mainly, a sub-pixel 202 (hereinafter, referred to as a G-cell 202) which displays a green color mainly, and a sub-pixel 203 (hereinafter referred to as a B-cell 203) which displays a blue color mainly. A frame portion indicated by a dotted line in FIG. 1A is an area corresponds to an aperture 216 having an area which is specified by structural members such as the data line 15 the gate line 12 and the storage capacitance line 13 and TFT 14 on the TFT substrate 10 shown in FIG. 1B. Because almost no light can penetrate those structural members when the CF substrate and the TFT substrate 10 are overlapped, an area within the frame portion is an area where the light can penetrate through it. In FIG. 1C, reference numerals 16 and 19 indicate a transparent pixel electrode and an insulative layer, respectively.

In the conventional CF substrate, only one color layer is arranged in each sub-pixel. However, in this exemplary embodiment, two or more color layers are arranged in at least one sub-pixel among three sub-pixels forming one pixel. For example, in a G-cell 202, although only a green layer (hereinafter, referred to as a G-layer 222) is at least arranged in the aperture, a red layer (hereinafter, referred to as a R-layer 221) and the G-layer 222 are arranged in the R-cell 201, and a blue layer (hereinafter, referred to as a B-layer 223) and the G-layer 222 are arranged in the B-cell 203. That is, the R-cell 201 and the B-cell 203 include a first area (a first color region 22a) where the color layer arranged originally in the sub-pixel is arranged and a second area (a second color region 22b) where the G-layer 222 is arranged. In the R-cell 201 and the B-cell 203, the G-layer 222 is arranged so as to separate the R-layer 221 and the G-layer 223 within the aperture of the respective sub-pixels by crossing there with the same width. Here, its shape is made a rectangle, and a layout of those three color layers is shown in FIG. 1D.

In an aforementioned structure, when the second color region 22b is arranged in the aperture edge of the sub-pixel, when the TFT substrate 10 and the CF substrate 20 are overlapped and then the positional displacement occurs, (that is, the fitting difference in the structure where the TFT substrate 10 and the CF substrate 20 are overlapped and fitted in the frame so as to be adjusted, but deviated from correct position), the area ratio of the color layer 22 changes, and thus there is a case that the desired chromaticity area is not obtained. Accordingly, in this exemplary embodiment, the color layer (the G-layer 222 in FIG. 1) crossing the adjacent sub-pixel is designed so as not to be arranged at the edge of the aperture. Specifically, minimum distance “c” from the short side of the aperture in FIG. 1A to the color layer end crossing the sub-pixel is set so as to be half or more of the distance which corresponds to the width of the smaller one of either a distance “2a” between the apertures in the sub-pixels adjacent to each other in a vertical direction and the distance “2b” between the apertures in the sub-pixels adjacent to each other in a lateral direction (that is, satisfying a relation of c>=a or c>=b).

Thus, according to a structure of the first exemplary embodiment, the chromaticity area of the LCD device can be changed without changing the emission spectrum of the light source and the spectral transmission characteristic of the color resist forming the color layer 22. The reason will be described in the following. For example, in the LCD device using a certain light source and the color resist without correction, it is supposed that the red and the blue belong to the chromaticity areas of non-mixed colors shown in FIG. 5 which does not meet the NTSC (National Television System Committee) standard. In order to make the chromaticity area of this LCD device to meet the NTSC standard, it is possible to produce the chromaticity area of mixed colors shown in FIG. 5 which meet the NTSC standard by just adding a suitable amount of the green in the red and the blue.

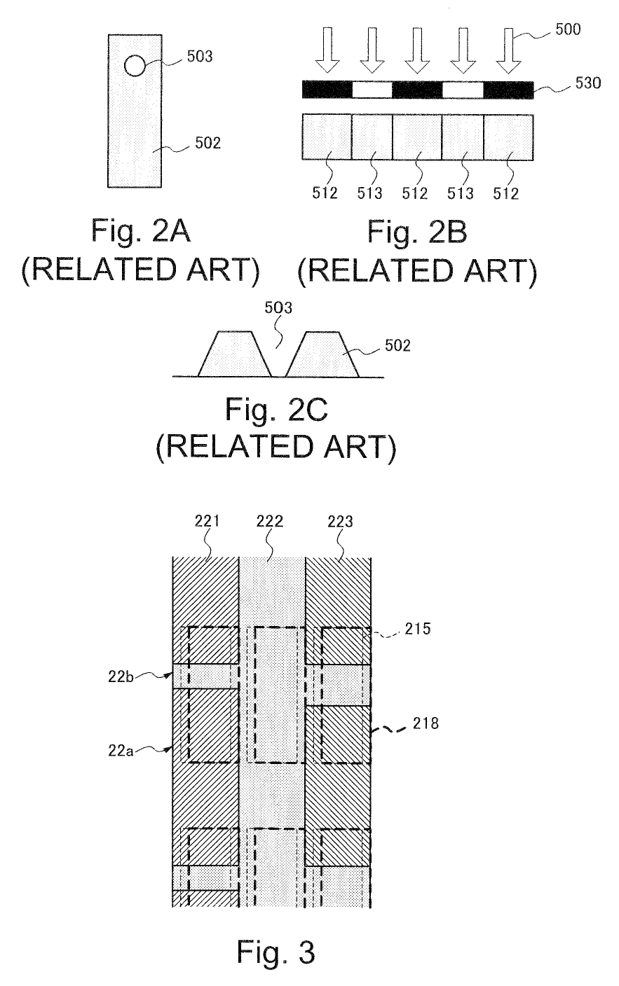

According to a structure of the first exemplary embodiment, it is available for a high-definition pixel. The reason will be described in the followings. In the first exemplary embodiment, different color layers arranged in one transmissive region are same as the primary color layer arranged in an adjacent pixel. The pattern of the color layer is generally made by using photolithographic technique as shown in FIG. 2 after coating resist material which is colored by dispersing pigment into it, for example. When using photolithographic technique, the end face tends to be the shape with the inclination because it undergoes the influence of the diffraction of the exposure light. Therefore, in the isolated pattern as shown in FIG. 2, the area from which the resist is removed becomes relatively small and results in difficulty for forming the minute pattern. In order to form such isolated pattern, when even the looseness by the process is considered, its diameter is needed to be no smaller than 15 μm. Considering the fitting displacement, when the distance from the isolated pattern to the optical transmissive region end is no smaller than 10 μm, and the distance between adjacent optical transmissive regions is set to 10 μm, the short side direction size of the sub-pixel needs to be no smaller than 45 μm. This pixel size is larger than the pixel size of the 4 inch size VGA (Video Graphics Array), and thus it means that the method using the isolated pattern cannot be applied to a high-definition LCD device used for a cellular phone or the like. On the other hand, a structure of the present invention can be applied to the high-definition pixel having a short side direction size of no more than 45 μm in the sub-pixel, because the isolated pattern does not exist.

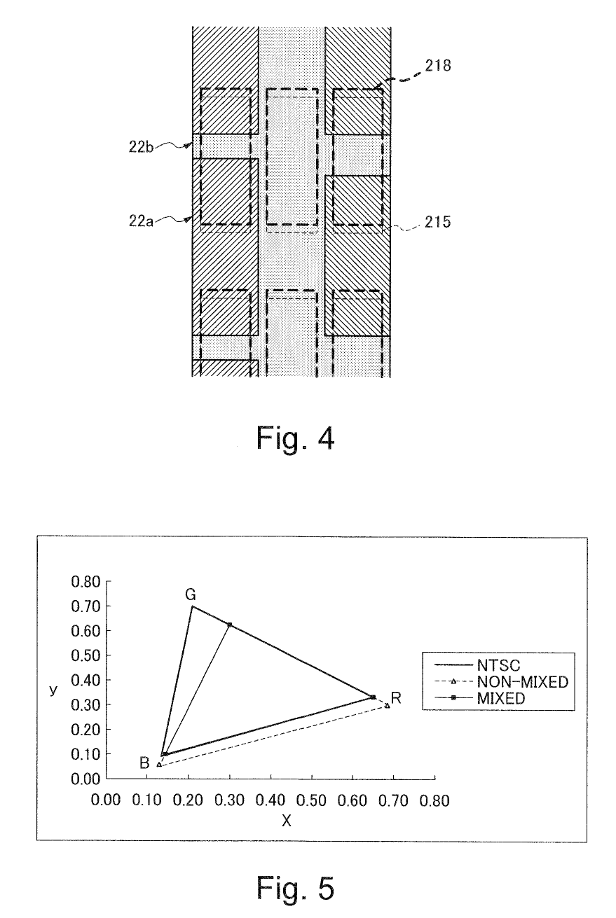

According to the structure of the first exemplary embodiment, it is difficult to change the chromaticity area even if the fitting displacement occurs such that the overlapping error is produced between the TFT substrate 10 and the CF substrate 20. The reason will be described as follows. FIG. 3 shows a comparison between two cases; one is that the CF substrate 20 and the TFT substrate 10 are deviated from a correct position in a lateral direction, i.e., an extending direction of the gate line 12, and which is indicated as an optical transmissive region or an aperture 218. The other case is that the CF substrate 20 and the TFT substrate 10 are not deviated from each other as shown as an aperture 215. Even in this case, the width of the color layer (the G-layer 222, for example) in the second color region 22b does not change. The second color region 22b is arranged so as to cross the primary color layer in each sub-pixel (the R-layer 221 of the R-cell 201 and the G-layer 223 of the B-cell 203, for example). Therefore, the area ratio of the first color region 22a and the second color region 22b does not change. Even when the fitting is displaced in a longitudinal direction, i.e., an extending direction of the data line 15 as shown in FIG. 4, in order to set the distance between the color layer (the G-layer 222, for example) and the aperture 218 in the second color region 22b larger than the amount of the fitting displacement, the area ratio of the first color region 22a and the second color region 22b does not change. Accordingly, the chromaticity area is not affected.

The width of the color layer 22 which continues from the adjacent sub-pixel is preferably same as a width of the desired chromaticity area, but it is not limited to the indicated structure. In the above-mentioned exemplary embodiment, although the G-layer 222 is extend to the adjacent sub-pixels (R-cell 201 and the B-cell 203) any color layer would be arbitrarily acceptable for extending it to the adjacent sub-pixels such that the R-layer 221 or the B-layer 223 can be extended to the adjacent sub-pixel. In the above-mentioned exemplary embodiment, the G-layer 222 is extended to both of the sub-pixels (the R-cell 201 and the B-cell 203). However, it can be arranged so as to be extended to only one sub-pixel (either the R-cell 201 or the B-cell 203).

### Exemplary Embodiment 2

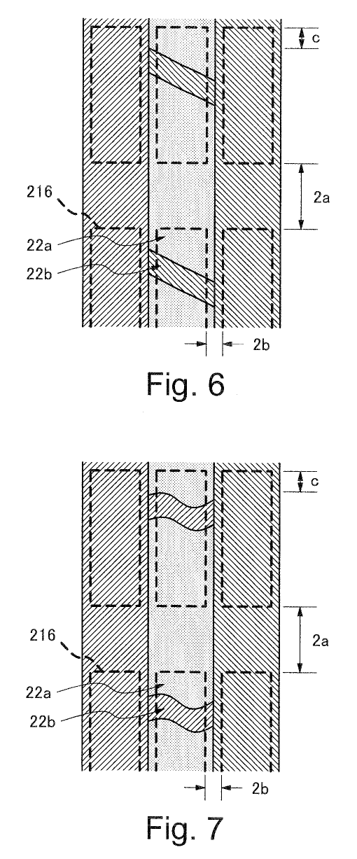

Next, the LCD device according to a second exemplary embodiment of the present invention will be described with reference to FIG. 6.

FIG. 6 shows an arrangement of the color layers on the CF substrate according to the second exemplary embodiment of the present invention. In this example, the second color region 22b is arranged such that the color layer 22 (here, the B-layer 223) of the sub-pixel arranged next to it is continuously extended so as to cross the first color region 22a. The second color region 22b has a shape of parallelogram.

Even in an aforementioned structure, when the second color region 22b is arranged in the aperture edge of the sub-pixel, and the TFT substrate 10 and the CF substrate 20 are overlapped and then the positional displacement occurs, the area ratio of the color layer 22 changes, and thus there is a case that the desired chromaticity area is not obtained. Accordingly, in this exemplary embodiment, minimum distance “c” from the short side of the aperture to the color layer end crossing the sub-pixel is set so as to be half or more of the distance which corresponds to the width of the smaller one of either a distance “2a” between the apertures in the sub-pixels adjacent to each other in a vertical direction and the distance “2b” between the apertures in the sub-pixels adjacent to each other in a lateral direction (that is, satisfying a relation of c>=a or c>=b).

As a result, even if the fitting displacement or overlapped error between the TFT substrate 10 and the CF substrate 20 occurs, the width of the color layer in the second color region 22b does not change. Therefore, the area ratio of the first color region 22a and the second color region 22b in the aperture does not change. Accordingly, the similar advantage as in the first exemplary embodiment can be obtained.

### Exemplary Embodiment 3

Next, the LCD device according to a third exemplary embodiment of the present invention will be described with reference to FIG. 7.

FIG. 7 shows an arrangement of the color layers on the CF substrate according to the third exemplary embodiment of the present invention. In this example, the second color region 22b is arranged such that the color layer 22 (here, the R-layer 221) of the sub-pixel arranged next to it is continuously extended so as to cross the first color region 22a. The second color region 22b has a shape of a capital letter “S”. The width of the “S” in the direction parallel to the data line 15 is made equal.

Minimum distance “c” from the short side of the aperture to the color layer end crossing the sub-pixel is set so as to be half or more of the distance which corresponds to the width of the smaller one of either a distance “2a” between the apertures in the sub-pixels adjacent to each other in a vertical direction and the distance “2b” between the apertures in the sub-pixels adjacent to each other in a lateral direction (that is, satisfying a relation of c>=a or c>=b).

As a result, even if the fitting displacement or overlapped error between the TFT substrate 10 and the CF substrate 20 occurs, the width of the color layer in the second color region 22b does not change. Therefore, the area ratio of the first color region 22a and the second color region 22b in the aperture does not change. Accordingly, the similar advantage as in the first exemplary embodiment can be obtained.

### Exemplary Embodiment 4

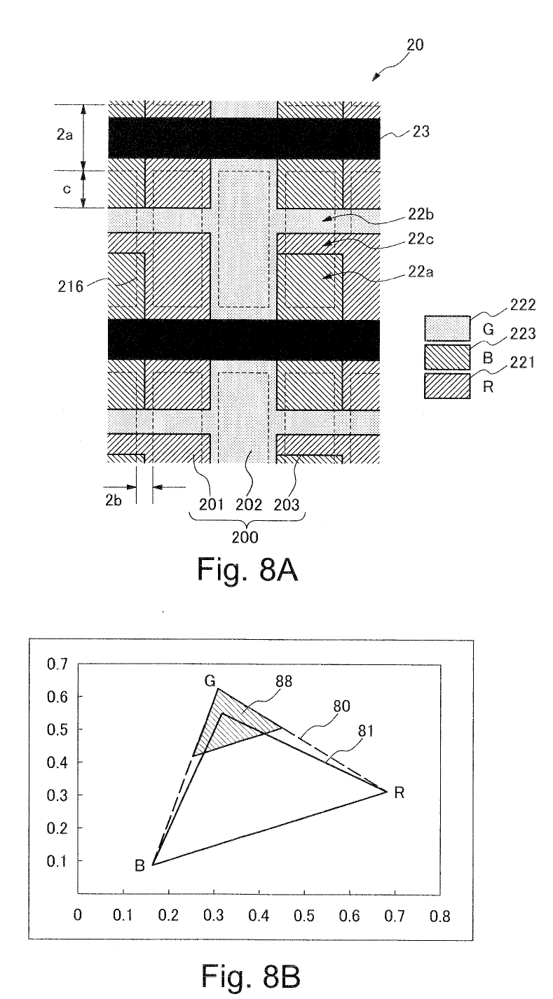

Next, the LCD device according to a fourth embodiment of the present invention will be described with reference to FIG. 8.

FIG. 8A shows an arrangement of the color layers on the CF substrate according to the fourth exemplary embodiment of the present invention. In this example, like the first exemplary embodiment, the second color region 22b is arranged such that the color layer 22 (here, the G-layer 222) of the sub-pixel (here, the G-cell 202) arranged next to it is continuously extended so as to cross the first color region 22a. This fourth exemplary embodiment is different from the first exemplary embodiment in that a third color region 22c different from the second color region 22b is arranged so as to cross the first color region 22a as well as the second color region 22b.

Minimum distance “c” from the short side of the aperture 216 to the color layer (closer to the short side) end crossing the sub-pixel 200 is set so as to be half or more of the distance which corresponds to the width of the smaller one of either a distance “2a” between the apertures in the sub-pixels adjacent to each other in a vertical direction and the distance “2b” between the apertures in the sub-pixels adjacent to each other in a lateral direction (that is, satisfying a relation of c>=a or c>=b).

FIG. 8B shows an example of the chromaticity diagram as indicated by a solid line 81, when the chromaticity adjustment by the fourth exemplary embodiment is performed. For example, when the adjustment is performed only for the G-layer 222 and the R-layer 221, it can be adjusted only at the range as indicated by a dotted line 80 on the line which connects the vertex G and R in FIG. 8B. However, it can be adjusted in the range 88 of the area indicated by the slanted line in the drawing by adding more G-layers 223. Therefore, the chromaticity area can be changed larger than any one of the first to third exemplary embodiments.

### Exemplary Embodiment 5

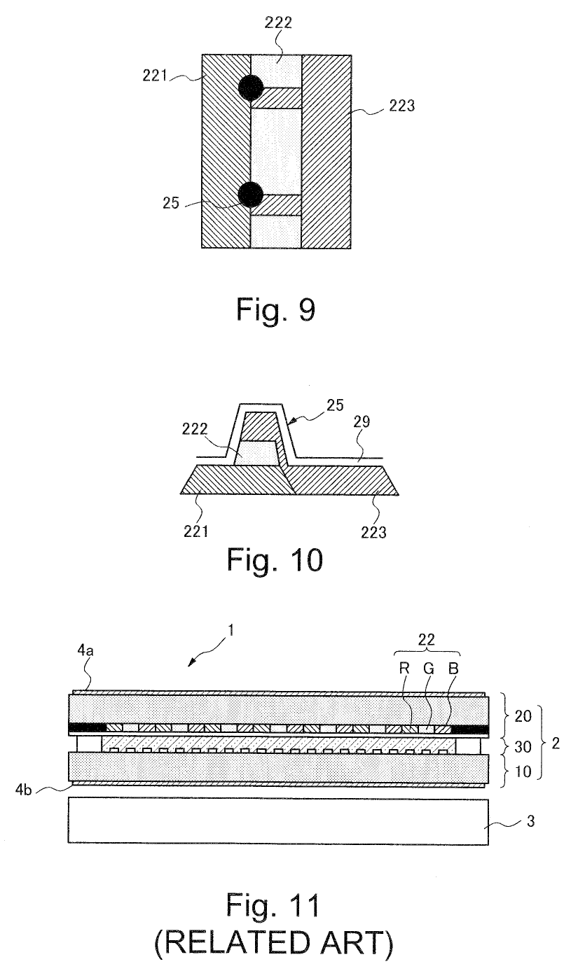

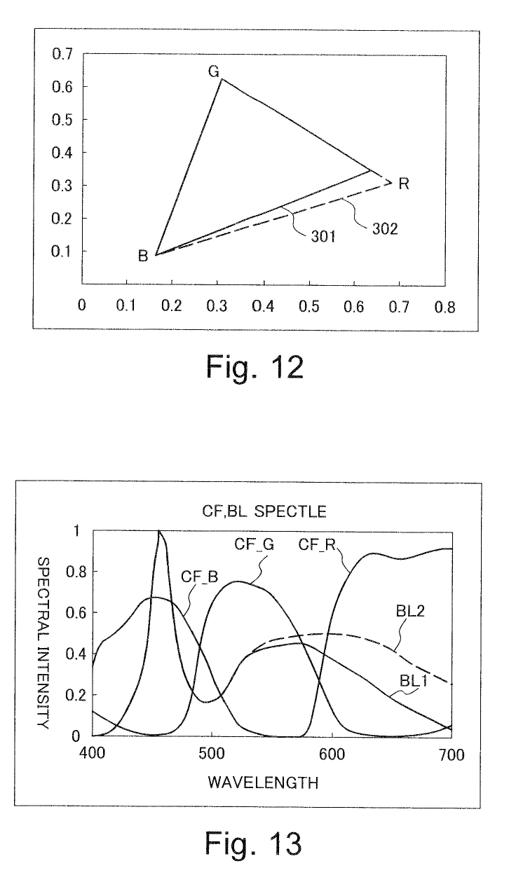

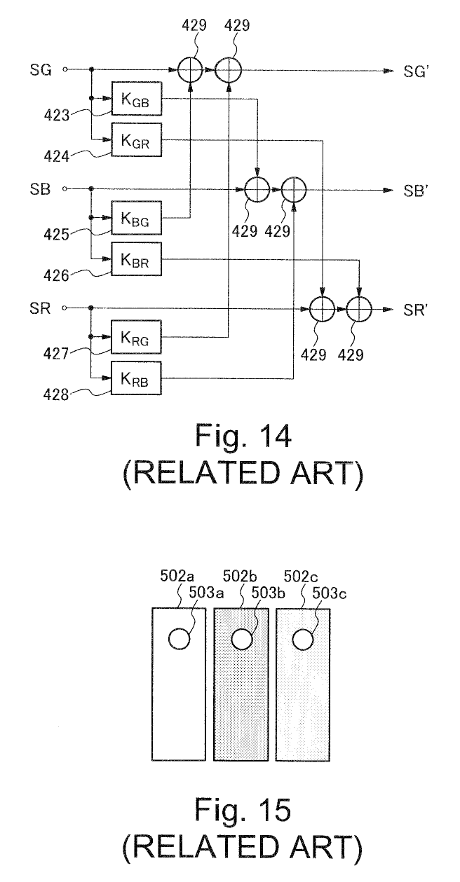

Next, the LCD device according to a fifth embodiment of the present invention will be described with reference to FIG. 9 and FIG. 10.

FIG. 9 shows an arrangement of the color layers on the CF substrate according to the fifth exemplary embodiment of the present invention. In this example, like the first exemplary embodiment, the second color region 22b is arranged such that the color layer 22 of the sub-pixel arranged next to it is continuously extended so as to cross the first color region 22a. The fifth exemplary embodiment is different from the first exemplary embodiment in that columnar spacers 25 are formed at portions where three kinds of color layers 22 are located. FIG. 10 shows a cross section of each of the columnar spacers 25. Each columnar spacer 25 is formed by laminating three kinds of color layer 22, that is, R-layer 221, G-layer 222 and B-layer 223. A reference numeral 29 in the drawing indicates a film of one of inorganic compound, a transparent electrode and those stacked films.

Thus, in a structure of the present invention, because the portion where three kinds of color layers 22 are located is produced inevitably, by laminating three color layers to form the columnar spacers 25, the manufacturing step can be simplified compared with the conventional method which forms the columnar spacers separately.

The present invention has a feature that the primary color layer and the color layer extended from the adjacent sub-pixel are arranged in at least one sub-pixel, and thus each color layer 22 can be arranged so as not to be overlapped or so as to be overlapped.

Since the feature of the present invention is the arrangement of the color layers on the CF substrate 20, the other arrangement of the members, structure and manufacturing method or the like are not limited to particular one. For example, the structure of the TFT substrate 10, the LC layer 30 and the polarizers 4a and 4b, the manufacturing method, the optical characteristic the drive system of the LCD and the lighting system of the backlight module are optional.

In each above-mentioned embodiment, although the transmissive type LCD device is indicated together with the CF substrate 20 according to the present invention, the present invention is not limited to the above-mentioned embodiments, and it can also be applied similarly to the transflective LCD device and the reflective type LCD device.

The present invention is available for not only the LCD device but also the terminal device using the LCD device.

According to the LCD device of the present invention, the LCD device includes a liquid crystal layer sandwiched between a first substrate and a second substrate. The first substrate is provided with sub-pixels arranged in an array such that each sub-pixel is arranged in each partitioned area surrounded with wiring lines respectively extending in a direction so as to be crossed each other. The second substrate is provided with color layers such that three consecutive sub-pixels with three color layers as one unit are repeatedly arranged in a predetermined pattern, and wherein a first color layer is arranged on an area opposing to an aperture of a first sub-pixel among the three sub-pixels, a second color layer and the first color layer extended from the first sub-pixels are arranged on an area opposing to an aperture of a second sub-pixel adjacent to one side of the first sub-pixel, and a third color layer and the first color layer extended from the first sub-pixels are arranged on an area opposing to an aperture of a third sub-pixel adjacent to other side of the first sub-pixel.

In the present invention, it is desirable to make a distance between an edge of the other color layer and a side of the aperture on the arrayed direction is set so as to be half or more of a distance which corresponds to a width of smaller one of either a distance between the apertures in the sub-pixels adjacent to each other in the arrayed direction and a distance between the apertures in the sub-pixels adjacent to each other in a direction normal to the arrayed direction.

According to the LCD device of the present invention, the chromaticity area of the LCD device can be changed without changing the emission spectrum of the backlight module light source and the spectral transmission characteristic of the material composing the color layers. This is because the chromaticity area can be easily adjusted by arranging the third color in the sub-pixel each having the first color and the second color, respectively.

According to the LCD device of the present invention, the chromaticity area of the LCD device can be changed without adding a new additional fabrication process of the CF substrate. Because only the ordinary color layers are sufficient for the adjustment of the chromaticity area.

According to the LCD device of the present invention, it is also available for the high-definition pixel. Because the isolated removing pattern does not exist in the pattern of each color layer, the pattern formation of the color layers becomes possible even if the pixel pitch becomes small.

According to the LCD device of the present invention, even if the fitting displacement or overlapped error between the TFT substrate 10 and the CF substrate 20 occurs, it is difficult for the chromaticity area to change. This is because the width and the area of the second color region crossing the primary color layer do not change.

According to the LCD device of the present invention, the columnar spacers can be made without adding a different process newly. Because there is a portion where three kinds of color layers are located inevitably in every one pixel including red, green and blue sub-pixels, and the columnar spacers can be formed by laminating all color layers in that portion.

While the invention has been particularly shown and described with reference to exemplary embodiments thereof, the invention is not limited to these embodiments. It will be understood by those of ordinary skill in the art that various changes in form and details may be made therein without departing from the spirit and scope of the present invention as defined by the claims.

What is claimed is:

1. A liquid crystal display device, comprising:
a first substrate provided with sub-pixels arranged in an array such that each sub-pixel is arranged in each partitioned area surrounded with wiring lines respectively extending in a direction so as to be crossed each other,
a second substrate provided with color layers such that three consecutive sub-pixels with three color layers as one unit are repeatedly arranged in a predetermined pattern, and a primary color layer for a first sub-pixel of said three sub-pixels and other color layer extended from an adjacent sub-pixel next to said first sub-pixel are arranged on an area opposing to an aperture of at least one sub-pixel among said three sub-pixels; and
a liquid crystal layer sandwiched between said first substrate and said second substrate.

2. A liquid crystal display apparatus, comprising:
a first substrate provided with sub-pixels arranged in an array such that each sub-pixel is arranged in each partitioned area surrounded with wiring lines respectively extending in a direction so as to be crossed each other,
a second substrate provided with color layers such that three consecutive sub-pixels with three color layers as one unit are repeatedly arranged in a predetermined pattern, and wherein a first color layer is arranged on a first area opposing to a first aperture of a first sub-pixel among said three sub-pixels, a second color layer and said first color layer extended from said first sub-pixels are arranged on a second area opposing to a second aperture of a second sub-pixel adjacent to one side of said first sub-pixel, and a third color layer and said first color layer extended from said first sub-pixels are arranged on a third area opposing to a third aperture of a third sub-pixel adjacent to other side of said first sub-pixel; and
a liquid crystal layer sandwiched between said first substrate and said second substrate.

3. The liquid crystal display device according to claim 2, wherein said second color layer extended from said second sub-pixel is arranged on said third area opposing to said third aperture of said third sub-pixel.

4. The liquid crystal display device according to claim 1, wherein said other color layer in each aperture is arranged so as to cross said aperture along an arrayed direction of said three sub-pixels.

5. The liquid crystal display device according to claim 4, wherein a width of said other color layer in each aperture is substantially constant in a direction crossing at right angles with said arrayed direction of said three sub-pixels.

6. The liquid crystal display device according to claim 4, wherein a distance between an edge of said other color layer and a side of said aperture on said arrayed direction is set so as to be half or more of a distance which corresponds to a width of smaller one of either a distance between said apertures in said sub-pixels adjacent to each other in said arrayed direction and a distance between said apertures in said sub-pixels adjacent to each other in a direction normal to said arrayed direction

7. The liquid crystal display device according to claim 1, wherein said three color layers are arranged so as not to be overlapped each other.

8. The liquid crystal display device according to claim 1, wherein said three color layers are laminated at an area where said three color layers are contacted each other to form a columnar spacer which specifies a gap between said first substrate and said second substrate.

9. A liquid crystal display device, comprising:
a first substrate provided with pixel regions associated with switching elements arranged in a matrix pattern, each of said pixel regions is constructed with a first sub-pixel, a second sub-pixel and a third sub-pixel;
a second substrate provided with a first area, a second area and a third area respectively associated with said first sub-pixel, said second sub-pixel and said third sub-pixel in that order and a first color layer, a second color layer and a third color layer are formed such that each color layer occupies a major area of corresponding each sub-pixel, at least one area among said first area, said second area and said third area being provided with a color layer partially extended from an area adjacent thereto; and
a liquid crystal layer sandwiched between said first substrate and said second substrate.
